(19) United States
(12) Patent Application Publication
(10) Pub. No.: US 2007/0038693 A1
(43) Pub. Date: Feb. 15, 2007

(54) Method and Processor for Performing a Floating-Point Instruction Within a Processor

(76) Inventors: Christian Jacobi, Schoenaich (DE); Matthias Klein, Boeblingen (DE); Silvia Mueller, Altdorf (DE); Matthias Pflanz, Schoenaich (DE); Jochen Preiss, Boeblingen (DE)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(21) Appl. No.: 11/462,069

(22) Filed: Aug. 3, 2006

(30) Foreign Application Priority Data
Aug. 10, 2005 (EP) 05107362.5

(51) Int. Cl. G06F 7/38

(52) U.S. Cl. 708/446

(57) ABSTRACT

The invention relates to a method for performing floating-point instructions within a processor of a data processing system is described, wherein an input of said floating-point instruction comprises a normal or a denormal floating-point number. Said method comprises the steps of storing said floating-point number, normalization of said floating-point number by counting the leading zeros of the mantissa, shifting the fraction part to the left by the number of leading zeros and simultaneously decrementing the exponent by one for every position that the fraction part is shifted to the left, wherein it the input is a normal floating point number the normalization is done after counting no leading zero of the mantissa, execution of a floating point instruction, wherein said normalized floating-point number is utilized as input for the floating point instruction, and storing of a floating-point result. Furthermore a processor to be used to perform said method is described.

### BACKGROUND OF THE INVENTION

The invention relates to a method for performing a floating-point instruction within a processor of a data processing system, and a corresponding processor. Especially, the invention relates to the processing of denormal floating point numbers.

Contemporary microprocessor instruction sets support the approximation of 2^{x}-computations and of log x-computations for logarithms, usually of base 2, where the operand and result of the instruction are floating-point numbers. When the input is very close to 0, then the floating-point representation is a special so-called denormal or subnormal number.

The IEEE 754 floating-point standard defines a set of normalized numbers and four sets of special numbers. The special numbers are Not-a-numbers (NaNs), infinities, zeros, and denormalized numbers, which are also referred to as subnormal or denormal numbers. Operations in the first three special numbers require no complex computation. The only type of special numbers that require computation for an arithmetic operation are denormal numbers.

Normalized numbers are represented by the following:
x=(−1)^{X}^{ₛ}−XᵢX_{f}·2^{X}^{ₑ}^{-bias} (1)
wherein X is the value of the normalized number, Xₛ is the sign bit, Xᵢ is the integer part, X_{f} is the fractional part of the significand, Xₑ is the exponent, and bias is the bias of the format, e.g. 127, 1023, and 16383, for single, double and quad. Regarding normalized numbers, the integer part Xᵢ is Xᵢ=1. The part Xᵢ·X_{f} is also called mantissa comprising the integer part Xᵢ and the fraction part X_{f}.

Denormal numbers are represented by the following:
x=(−1)^{X}^{ₛ}·0.X_{f}·2^{1-bias} (2)
with X_{f}≠0. Compared with normal numbers it can be seen that denormal numbers are characterized in Xₑ=0, Xᵢ=0 and X_{f}≠0. According to the IEEE 754 floating-point standard, the exponent Xₑ-bias is raised by one if X_{c}=0.

Computations in the area of denormal numbers are often complex and involve a lot of additional hardware. Due to this, prior art for the computation of log x- and power-of-two approximations in the area of denormal numbers only detects this situation and then raises an interrupt to software, wherein the actual computation is carried out by a computer program instead of inside the processor hardware.

This requires additional control hardware that is large and complex, and also takes much longer per computation than a hardware solution.

Basically it is well known, how to perform 2^{x} and log x estimations within a data processing system.

U.S. Pat. No. 6,178,435 B1 describes a method for performing a power-of-two estimation on a floating-point number within a data processing system comprising a processor. Thereby the floating-point number is a normalized number with a mantissa comprising a leading one and a fractional part. In order to estimate the power of two of the floating-point number, the mantissa is partitioned into an integer part and a fraction part, based on the value of the exponent. A floating-point result is formed by assigning the integer part of the floating-point number as an unbiased exponent of the floating-point result, and by converting the fraction part of the floating-point number via a table lookup to become a fraction part of the floating-point result. Thereby the unbiased exponent can be obtained by subtracting the bias from the exponent as shown in equations (1) and (2).

U.S. Pat. No. 6,182,100 B1 describes a method for performing a logarithmic estimation on a positive floating-point number within a data processing system comprising a processor. Thereby a fraction part of an estimate is obtained via a table lookup utilizing the fraction part of the floating-point number as input. An integer part of the estimate is obtained by converting the exponent bits to an unbiased representation. The integer part of the estimate is then concatenated with the fraction part of the estimate to form an intermediate result. Subsequently, the intermediate result is normalized to yield a mantissa, and an exponent part is produced based on the normalization. Finally, the exponent part is combined with the mantissa to form a floating-point result.

The disadvantage of these methods is that denormal inputs lead to an imprecise result due to the table lookup.

Another disadvantage of that method is that denormal results, particularly denormal intermediate results cannot be handled and are rounded off to zero.

It is also known to simultaneously detect if a denormal floating-point input occurs during the execution of a floating-point instruction. If such a denormal floating-point input occurs, the floating-point instruction is interrupted, and the Floating-Point-Unit, FPU is normalizing the denormal floating-point input to a normalized floating-point number. After normalization, the execution of the floating-point instruction is continued.

The disadvantage of this method is that depending on the floating-point input the execution of the floating-point instruction has to be stopped. Thereby the interface between FPU and issue-logic and also the issue-logic itself gets very complex. Furthermore such a method is not practicable for high-speed processors.

Such solutions are not practicable in combination with high-speed processing. For high-speed processing solutions are required to execute all kind of floating-point instructions within the processor of a data processing system.

### SUMMARY OF THE INVENTION

It is therefore an object of the invention to provide a method to perform floating-point instructions including the execution of power-of-two and logarithmic approximations within a processor of a data processing system, wherein the floating-point input may comprise normal and denormal numbers, plus a processor that can be used to perform said method.

The invention's technical purpose is met by said method according to the independent claims, wherein said method comprises the steps of:
storing said floating-point number within a memory of a data processing system having a processor, wherein said floating-point number includes a sign bit, a plurality of exponent bits and a mantissa comprising a leading one or a leading zero and a fraction part,
normalization of said floating-point number by counting the leading zeros of the mantissa, shifting the fraction part of the mantissa to the left by the number of leading zeros and simultaneously decrementing the exponent by one for every position that the fraction part is shifted to the left, wherein if the input is a normal floating point number the normalization is done after counting no leading zero of the mantissa,
execution of a floating point instruction in a well known manner in a way a floating-point instruction comprising normal numbers usually is carried out, wherein said normalized floating-point number is utilized as input for the floating point instruction, and
storing of a floating-point result of said floating point instruction in said memory.

The storing of the floating-point number within the memory is done by at least storing the fraction part of the mantissa and the exponent of the floating-point number within the memory. It is not absolute necessary to store the integer part Xᵢ, since this is typically a one or a zero, depending on the floating-point number being a normal or a denormal number (equations (1) and (2)).

Thereby it is important to mention that the execution of the floating point instruction by utilizing said normalized floating-point number as input can be done in a way floating-point instructions comprising normal numbers are carried out, e.g., as described in U.S. Pat. No. 6,178,435 B1 and U.S. Pat. No. 6,182,100 B1.

The advantages of the invention are achieved by performing a normalization step before executing the floating-point instruction, independent if the floating-point number to be used as input for said floating-point instruction is a normal or a denormal number. The normalization can be done e.g. by using a normalizer comprised within the hardware of a Fused Multiply and Add unit (FMA). It is also thinkable to use an additional normalizer. Doing so, the execution of calculations with denormal floating-point numbers and/or denormal floating-point results is supported. A main advantage is that due to the invention no interruption of the execution of the floating-point instruction within the processor of a data processing system occurs. Preferably the normalization step is adapted to power-of-two and logarithmic estimations.

In a preferred embodiment of said invention, said floating-point instruction is a log x estimation and the execution of the floating point instruction comprises the steps of:
obtaining a fraction part of an estimate number via a table lookup utilizing the fraction part of said normalized floating-point number as input,
obtaining an integer part of said estimate number by converting said exponent bits to an unbiased representation,
concatenating said integer part with said fraction part to form an intermediate result,
normalizing said intermediate result to yield a mantissa, and producing an exponent part based on said normalizing step, and
combining said exponent part and said mantissa to form a floating-point result and
storing said floating-point result in said memory.

In another preferred embodiment of said invention, said execution of the floating point instruction further includes a step of complementing said intermediate result if the unbiased exponent of said normalized floating-point number is negative.

In an additional preferred embodiment of said invention, said normalizing step within the execution of the floating-point instruction further includes a step of removing leading zeros and a leading one from said intermediate result.

In a particularly preferred embodiment of said invention, said method further includes a step of subtracting the number of leading zeros and said leading one in said removing step from the exponent within the execution of the floating-point instruction.

A preferred embodiment of said invention is characterized in that a pseudo instruction that passes the floating-point number through a leading-zero-counter and a normalization shifter is performed to normalize said floating-point number, wherein the output of the normalization shifter is tapped-off and the result is put onto the lookup table. By doing so the floating-point number is normalized before performing the table lookup. Thereby a second normalization step takes place after the table lookup, if the intermediate result is a denormal number.

In a preferred embodiment of said invention, said floating-point instruction comprises a power-of-two estimation and the execution of the floating-point instruction comprises the steps of:
partitioning said mantissa of said normalized floating-point number into an integer part and a fraction part, based on said exponent bits,
yielding a floating-point result by assigning said integer part of said normalized floating-point number as an unbiased exponent of said floating-point result, and by converting said fraction part of said normalized floating-point number via a table lookup to become a fraction part of said floating-point result, and
storing said floating-point result in said memory.

In another preferred embodiment of said invention, said execution of the floating-point instruction further includes a step of complementing said integer part and said fraction part of said normalized floating-point number if said normalized floating-point number is negative.

In an additional preferred embodiment of said invention, said execution of the floating-point instruction further includes a step of adding the bias of the format to said unbiased exponent of said floating-point result to form a biased exponent of said floating-point result.

In a particularly preferred embodiment of said invention, said floating-point result is forced to one if the input of the floating-point instruction comprises a denormal number.

A preferred embodiment of said invention is characterized in that the result of said floating-point instruction is denormalized by shifting the mantissa of the result to the right by padding leading zeros on the left side of the mantissa and simultaneously increasing the exponent by one for every position the mantissa is shifted to the right until the exponent is within said limitation, if the exponent of said floating-point result of said floating-point instruction is smaller than a limitation given by the architecture, e.g., the bias format of the data processing system Doing so the invention allows to handle denormal floating-point or intermediate results. Such denormal floating-point or intermediate results particularly can occur when executing power-of-two estimations with very small result exponents. Thereby power-of-two estimations comprise also other power estimations that can be executed within the binary system of the processor. According to the invention it is possible to reuse the existing normalization hardware within the processor hardware for denormalization.

In another preferred embodiment of said invention, a rounding step is performed after denormalization of said floating-point result or said intermediate result, wherein bits of said fraction part sticking out at the right within said denormalization are considered within a rounding decision. This can be done by reusing an existing rounder hardware being arranged within the processor hardware.

In a particularly preferred embodiment of the invention, said method is performed by a Processor comprising means to normalize a floating-point number used as input for a floating-point instruction, and means to execute said floating-point instruction by utilizing said normalized floating-point number.

A preferred embodiment of said processor according to the invention is characterized in that the means to normalize a floating-point number comprise a leading zero counter and a normalization shifter. Thereby it is thinkable that the normalization shifter is an additional one or a normalization shifter already comprised within a regular Floating-Point-Unit (FPU) hardware.

Another preferred embodiment of said processor according to the invention comprises means to denormalize floating-point results and/or intermediate results.

### BRIEF DESCRIPTION OF THE DRAWINGS

The present invention and its advantages are now described in conjunction with the accompanying drawings.

FIG. 1 is showing a scheme of a realization of a power-of-two estimation according to the invention within a processor hardware, and

FIG. 2 is showing a scheme of a realization of a log x estimation according to the invention within a processor hardware.

### DETAILED DESCRIPTION

Initially a first embodiment of the invention is described comprising an implementation of a power-of-two approximation instruction that performs the whole computation in hardware without interrupting into software. The described solution for denormal numbers also reuses hardware which is already available for the computation of regular floating-point instructions such like fused-multiply-and-add, FMA. Again, the elimination of the need for an interrupt on denormal inputs or outputs simplifies the control design, in particular for the instruction sequencer. It also improves performance on denormal numbers.

In order to describe the power-of-two approximation, initially the common way of computing power-of-two approximations without denormal inputs is sketched: The normal floating-point number x is converted into a fixed-point number with n bits in front of the binary point and m bits behind the binary point. This conversion works by shifting the mantissa M of the floating-point number according to a number directly derived from the exponent Xₑ of the floating-point number. The mantissa of the derived fixed-point number is denoted “i.f.”, where “i” is the integer part and “.f” is the fractional part of the converted x. The conversion fulfills the requirement x=i.f. The approximation of
2^{x}=2^{i.g}=2ⁱ·2^{g}
is now obtained by using i as result exponent, that is appropriately transformed into the format of the floating-point exponent, wherein an approximation of 2^{.g} is used as a result fraction that is obtained from a lookup table with .g as input. Note that 0<.g<1, and thus 1≦2^{.g}<2 which satisfies the requirements for the result fraction.

For handling denormal floating-point input and floating-point or intermediate results, the invention comprises the following:

III) Denormal inputs: when a denormal floating-point number to be used as input for a power-of-two floating-point instruction is detected, the result of said power-of-two estimation floating is forced to 1.0. Denormal numbers are very close to 0, thus 2^{x}=1.

IV) Denormal outputs: as said above, i becomes the result's exponent. However, if i<X_{e min}, the exponent Xₑ underflows and thus a denormal result has to be produced. In order to do so, the approximated result's fraction X_{fr} needs to be shifted to the right (denormalization shift) by the amount that i underflows. This produces the denormal result with leading zeros in the fraction, in order to perform this de-normalization, the standard FPU's normalization shifter is re-used:
i) the result fraction obtained from the lookup table is multiplexed into the input of the normalization shifter. The normalization shifter can only shift to the left, wherein X_{fr} needs to be right-shifted for denormalization. Therefore, X_{fr} is put at the right end of the normalization shifter, padded with zeros to its left. Thereby the normalization shifter is at least twice as wide as the result fraction X_{fr}. Thus it does not have to be enlarged for the padded approximation.
ii) The 2^{x}-logic computes a normalization shift amount which is multiplexed into the regular shift-amount-input of the normalization shifter. The shift-amount can easily be computed from i: if i is large enough, then a constant normalization amount is computed such that all leading zeros, that is a constant number, are shifted away and thus the not-denormalized X_{fr} is shifted to the left-side of the shifter-output. Otherwise, if i is too small and thus a denormal result has to be produced, a shift-amount is calculated such that the normalization shifter only performs a partial normalization and the correct number of leading zeros is preserved. Note that this computation of the correct “partial shift amount” depends only on i that is a narrow binary number (e.g., 9/12 bits for single/double precision) and thus requires only little hardware. The shift-amount does not depend on the wider X_{fr}.
iii) After the denormalization is performed, some bits of the partially-normalized X_{fr}′ may stick out at the right side when the target format is not wide enough to accommodate all bits of X_{fr}′. This occurs in particular when X_{fr}′ was partially normalized to contain many leading zeros. In that case a rounding-step needs to be performed, where the bits sticking out at the right go into the rounding-decision. This rounding-step for the 2^{x} computation comes with no additional cost from the standard FPU's rounding hardware that is connected to the output normalization shifter.

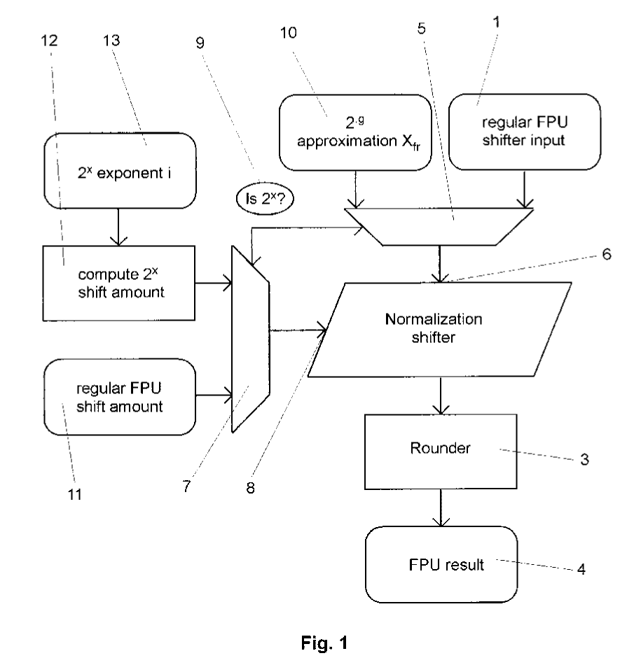

An example of a scheme how to realize the power-of-two estimation according to the description above within processor hardware is shown in FIG. 1. For Fused-multiply-add type instructions the regular floating point unit (FPU) shifter input 1 is put onto a normalization shifter 2. The output of the normalization shifter 2 is sent to a rounder circuitry 3, which in turn computes the final FPU result 4. In order to reuse this hardware for power-of-two estimate instructions, a multiplexer 5 is added in front of the data-input 6 of the normalization shifter 2. Also a second multiplexer 7 is added in front of the shift amount input 8 of the normalization shifter. The multiplexer 5 allows passing the regular FPU shifter input 1 to the normalization shifter 2 during normal operation. If the performed operation is a power-of-two estimate instruction the control logic asserts a power-of-two-signal 9 controlling the multiplexers 5, 7 accordingly. This is necessary in order to put a 2^{.g} approximation 10 of the fraction part X_{fr} on the normalization shifter 2. The multiplexer 7 allows either to select the regular FPU shift amount 11 for Fused Multiply and Add (FMA) instructions etc., or alternatively to select the shift amount 12 needed to normalize or partly-normalize the 2^{.g} estimation 10 if a power-of-two estimation occurs. Thereby the shift amount 12 depends on the exponent 13 of the result of the power-of-two estimation.

Thereby the multiplexers 5, 7 shown in FIG. 1 can be replaced by simpler gates, e.g., NAND-gates, if the second input from the regular FPU instruction is guaranteed to have specific values when a 2^{x}-instruction finishes. This can oftentimes save additional logic levels due to the multiplexers 5, 7.

In the following a second embodiment of the invention is described comprising an implementation of a log-x-approximation instruction that performs the whole computation within processor hardware without interrupting into software. The described solution for denormal numbers preferably reuses hardware which is already available for the computation of regular floating-point instructions such like fused-multiply-and add, FMA. The elimination of the need for an interrupt at denormal inputs simplifies the control design, in particular for the instruction sequencer. It also improves performance on denormal numbers.

In order to describe a log-x-approximation initially the common way computing log-x-approximations without denormal inputs is sketched. The number x is given as a floating-point-number according to equation (1). It is assumed that Xₛ=0 and X_{f}>0, i.e., x>0, since otherwise the logarithm does not exist. In the following, the mantissa M=Xᵢ.X_{f} will be used. For the sake of description we also assume that Xₑ is the unbiased exponent value, raised by 1 if x is denormal, as demanded by the IEEE 754 floating-point standard.

The number x is called normal if Xₑ>X_{e min}, the minimum exponent, and 1≦M<2. If Xₑ=X_{e min} and 0<M<1 then x is called denormal. For normal numbers, the logarithm is usually computed as
log x=log(2^{X}^{ₑ}·M)=Xₑ+log M=Xₑ+IM.

Thereby IM is an approximation of log M taken from a lookup-table which is sufficiently precise. The result Xₑ+IM is usually treated as fixed-point number which is then converted to a floating-point number by appropriately shifting it, based on the number of leading zeros of Xₑ. This basic algorithm leads to a problem in the context of denormal input numbers, which is solved by the invention.

For denormal inputs the lookup table is only sufficiently precise if the significant digits of M are the most-significant bits of M. If M starts as M=0.0 . . . , then the significant digits “yyy” are at the less-significant positions (M=0.0 . . . 0yyy) that are not fully taken into account by the lookup table. In order to circumvent this problem and still obtain a sufficiently precise approximation IM of log M, M is normalized before executing the floating-point instruction. The process of normalizing M comprises counting the leading zeros of M, and then shifting M to the left by this number of leading zeros. In order to do so, two implementations can be chosen:

I) Reuse of the standard normalization shifter: Standard implementations of floating-point units comprise a leading-zero-counter, LZC, plus a normalization shifter for handling standard instructions like addition. This normalization shifter can be reused for the purpose of normalizing M for the log-x computation. In order to do so, a pseudo-instruction x+0 is executed as a regular add-instruction which puts x on the regular LZC and normalization shifter. Thereby it is also thinkable to compute another similar instruction. Instead of finishing the instruction as a regular add instruction, the output of the normalization shifter is tapped-off and the result is put onto the lookup table. In that way normalization is performed by re-using already-existing hardware only, wherein the significant digits needed for the lookup table for log-x are put into the most-significant positions of M.

II) As opposed to re-using the standard shifter, an additional normalization shifter can be build, consisting of a LZC and a normalization shifter. This is advantageous for not disturbing regular instructions during log-x computations.

During normalization the exponent Xₑ is adjusted according to the shift-amount, wherein Xₑ is decremented for every position that M is shifted to the left. The newly obtained exponent Xₑ′ and the normalized mantissa M′ are then taken for the computation of log x as log x=Xₑ′+IM′, where IM′ is obtained from the lookup table with M′ as input.

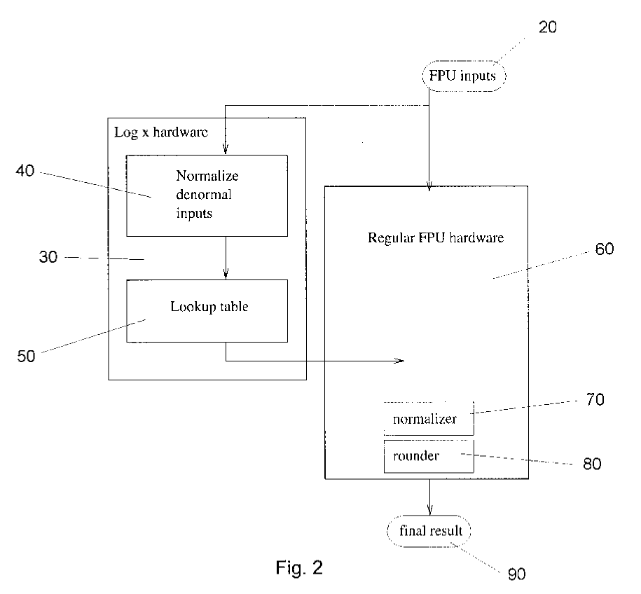

An example of a scheme how to realize the log X estimation according to the description above is shown in FIG. 2. For log x estimate computations the FPU inputs 20 are fed into a special log x hardware block 30 comprising a normalizer 40. Thereby the FPU inputs 20 can be normal or denormal floating-point numbers. Within the log x hardware block 30 the FPU inputs 20 are normalized to normal floating-point numbers in case they are denormal. The normalized FPU input 20 is then put onto a lookup table 50 to obtain the fraction part of the log x estimate. The log x hardware block 30 also combines this fraction part with the normalized exponent to receive an intermediate result. The intermediate result is then putted back at a suitable position into the regular FPU hardware block 60 comprising a second normalizer 70 and a rounder 80. The intermediate results then flows further through at least the normalizer 70 and the rounder 80 of the FPU hardware block 60 to receive a final result 90.

It is important to mention that in modern micro-architectures, it is often hard or impossible to trap into software based on a lately-detected data-dependent condition like the denormal condition, since the instruction sequencer has already progressed to the execution of newer instructions. This is regularly the case for high-frequency microprocessors that are very deeply pipelined. In such a setting denormal input handling in hardware is mandatory.

While the present invention has been described in detail, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

1. Method for performing a floating-point instruction within a processor of a data processing system, wherein an input of said floating-point instruction comprises a normal or a denormal floating-point number, said method comprising the steps of:
storing said floating-point number within a memory, wherein said floating-point number includes a sign bit, a plurality of exponent bits and a mantissa comprising a leading one or a leading zero and a fraction part,
normalization of said floating-point number by counting the leading zeros of the mantissa, shifting the fraction part to the left by the number of leading zeros and simultaneously decrementing the exponent by one for every position that the fraction part is shifted to the left, wherein if the input is a normal floating point number the normalization is done after counting no leading zero of the mantissa,
execution of a floating point instruction in a well known manner, wherein said normalized floating-point number (x=(=1)^{X}^{ₛ}·M′·2^{X}^{ₑ}^{′-bias}) is utilized as input for the floating point instruction, and
storing of a floating-point result of said floating point instruction in said memory.

2. Method according to claim 1, wherein the floating-point instruction is a log x estimation and the execution of the floating point instruction comprises the steps of:
obtaining a fraction part of an estimate number via a table lookup utilizing the fraction part of said normalized floating-point number as input,
obtaining an integer part of said estimate number by converting said exponent bits to an unbiased representation,
concatenating said integer part with said fraction part to form an intermediate result,
normalizing said intermediate result to yield a mantissa, and producing an exponent part based on said normalizing step, and
combining said exponent part and said mantissa to form a floating-point result and
storing said floating-point result in said memory.

3. Method according to claim 2, wherein said execution of the floating point instruction further includes a step of complementing said intermediate result if the unbiased exponent of said normalized floating-point number is negative.

4. Method according to claim 2, wherein said normalizing step within the execution of the floating-point instruction further includes a step of removing leading zeros and a leading one from said intermediate result.

5. Method according to claim 41 wherein said method further includes a step of subtracting the number of leading zeros and said leading one in said removing step from the exponent within the execution of the floating-point instruction.

6. Method according to claim 1, wherein to normalize said floating-point number a pseudo instruction is performed that passes the floating-point number through a leading-zero-counter and a normalization shifter, wherein the output of the normalization shifter is tapped-off and the result is put onto the lookup table.

7. Method according to claim 1, wherein the floating-point instruction comprises a power-of-two estimation and the execution of the floating-point instruction comprises the steps of:
partitioning said mantissa of said normalized floating-point number into an integer part and a fraction part, based on said exponent bits,
yielding a floating-point result by assigning said integer part of said normalized floating-point number as an unbiased exponent of said floating-point result, and by converting said fraction part of said normalized floating-point number via a table lookup to become a fraction part of said floating-point result, and
storing said floating-point result in said memory.

8. Method according to claim 7, wherein said execution of the floating-point instruction further includes a step of complementing said integer part and said fraction part of said normalized floating-point number if said normalized floating-point number is negative.

9. Method according to claim 7, wherein said execution of the floating-point instruction further includes a step of adding the bias of the format to said unbiased exponent of said floating-point result to form a biased exponent of said floating-point result.

10. Method according to claim 7, wherein said floating-point result is forced to one if the input of the floating-point instruction comprises a denormal number.

11. Method according to one of the previous claims, wherein, if the exponent of said floating-point result of said floating-point instruction is smaller than a limitation given by the data processing system, the result of said floating-point instruction is denormalized by shifting the mantissa of the result to the right by padding leading zeros on the left side of the mantissa and simultaneously increasing the exponent by one for every position the mantissa is shifted to the right until the exponent is within said limitation.

12. Method according to claim 11, wherein after denormalization of said floating-point result or said intermediate result a rounding step is performed, wherein bits of said fraction part sticking out at the right within said denormalization are considered within a rounding decision.

13. Processor to be used to perform the method of claim 1, comprising means to normalize a floating-point number used as input for a floating-point instruction, and means to execute said floating-point instruction by utilizing said normalized floating-point number.

14. Processor according to claim 13, wherein the means to normalize a floating-point number comprise a leading zero counter and a normalization shifter.

15. Processor according to claim 13, comprising means to denormalize floating-point results and/or intermediate results.
